(19) United States
(12) Patent Application Publication
(10) Pub. No.: US 2004/0203260 A1
(43) Pub. Date: Oct. 14, 2004

(54) Component arrangement

(76) Inventors: Christian Block, Stainz (AT); Christian Faistauer, Frauental (AT); Bernhard Reichel, Deutschlandsberg (AT)

Correspondence Address: FISH & RICHARDSON PC, 225 FRANKLIN ST, BOSTON, MA, 02110, US

(21) Appl. No.: 10/487,401

(22) PCT Filed: Aug. 13, 2002
(86) PCT No.: PCT/DE02/02966

(30) Foreign Application Priority Data
Aug. 31, 2001 (DE) 101 42 655.0

(51) Int. Cl. H01R 12/00

(52) U.S. Cl. 439/65

(57) ABSTRACT

The invention relates to a component arrangement in which an electric component (5) is lowered into an indentation (4) of a circuit board (1) and in which the electric component (5) is attached to an auxiliary circuit board (6), which is connected in turn to the circuit board (1). By lowering the electric component (5) in the indentation (4) of the circuit board (1), the component remainder (U) can be reduced advantageously.

The invention relates to a component arrangement with an electric component and a circuit board.

Component arrangements are known of the type mentioned in the introduction in which the electric component is attached to the upper side of the circuit board. Such component arrangements are also used in mobile telephones, among other places. In this case, the electric components being considered are, for example, microwave ceramic filters in the form of duplexers.

Known component arrangements have the disadvantage that the construction height of the component arrangements cannot be reduced without difficulty, as would be desirable, especially as a consequence of advances in miniaturization, because of the component residue on the upper side of the circuit board.

A reduction in the component residue of the component arrangement could be achieved by reducing the height of the electric component. A reduction in the component height requires significant development expense, however, delaying the production of marketable products, which is not desirable. In addition, reducing the component height means, in most cases, worsening of the electrical properties of the electric components, especially in the field of microwave ceramic filters. This is because the electrical properties of the electric components react sensitively to changes in geometry.

The goal of the present invention is therefore to provide a component arrangement of the type mentioned in the introduction in which the component residue on one side of the circuit board is reduced.

This goal is achieved according to the invention by a component arrangement according to patent claim 1. Advantageous embodiments of the invention can be seen in the other patent claims.

The invention provides a component arrangement that has a circuit board with an upper and a lower side. The circuit board also has an indentation, into which an electric component is lowered. The electric component is attached to an auxiliary circuit board that is attached to the circuit board.

In a first embodiment of the invention, the auxiliary circuit board can be attached to the lower side of the circuit board.

Lowering the electric component into the indentation of the circuit achieves the reduction of the structural height of the component arrangement on the upper side of the circuit board.

In an advantageous embodiment of the invention, one or more spacing elements can be placed between the auxiliary circuit board and the circuit board to define the distance between the auxiliary circuit board and the circuit board and thereby the degree of the lowering of the component into the indentation. A ring-shaped element in which the component lies can be considered, for example, or advantageously several pieces formed from solder, miniature circuit boards, or also metallic ceramic bodies.

Pieces formed from solder have the advantage that, when a suitable metal alloy is chosen for the solder, an economical soldering process according to the so-called “reflow process” can be applied appropriately. Moreover, pieces formed from solder have the advantage they are suitable for application to either the auxiliary circuit board or to the circuit board, according to the surface-mounting technique for plugging into the circuit board, in which case connecting elements pushed through the circuit board are avoided. Plugging the auxiliary circuit board into the circuit board can be done in this case with an auxiliary circuit board to which the electric component has already been attached.

Miniature circuit boards with dimensions of 1×1 mm, for example, or metal-plated ceramic bodies have the advantage that the distance to be set between the auxiliary circuit board and the circuit board can be defined exactly by standardized elements that are available for mass production. In regard to the use of metal-plated ceramic bodies, ceramic components can be considered that correspond, for example to the usual geometries (structural shapes) 0603 or 0805.

In an especially advantageous embodiment, the invention can be implemented in such a way that the spacing elements transmit the electrical contact between connections of the component and the associated connecting surfaces of the circuit board. For this, the auxiliary circuit board has first contact surfaces that are in contact with connectors of the component. The auxiliary circuit board also has second connecting surfaces that are in contact with the connecting surfaces of the circuit board. The first connecting surfaces of the auxiliary circuit board are in contact with the second contacting surfaces, for example by means of conducting paths, in such a way that the connectors of the component are connected to the associated connectors of the connecting surfaces of the circuit board so as to conduct electricity.

The second connecting surfaces of the auxiliary circuit board cover the connecting surfaces of the circuit board in this case in such a way that the electrical contact between the auxiliary circuit board and the circuit board can be achieved by simple insertion of electrically conducting contact elements at least on their surfaces.

Since the electric component in most cases occupies only a fraction of the area of the circuit board, a board whose area is significantly smaller than the surface of the circuit board is sufficient for the auxiliary circuit board. In connection with a smaller circuit-board surface, the thickness of the circuit board can be made thinner with adequate stability. In this way, the total structural height of the component arrangement according to the invention can be reduced in an advantageous manner. It is accordingly advantageous that the auxiliary circuit board be thinner than the circuit board.

In another advantageous embodiment of the invention, additional electric components are arranged on the upper side and the lower side of the circuit board. Such two-sided circuit boards are often used in the mobile-radio industry. The component arrangement according to the invention can be used especially advantageously here, since on the back side of the circuit board space is used for the additional components located thereon, so to speak, and the electric component on the front side of the conducting place is lowered and thus does not further disturb the electric components borne on the back side of the circuit board. Only the indentation and the areas necessary for attaching the auxiliary circuit board to the back side of the circuit board must be kept of additional components. In this case, not only the structural height of the component arrangement on one side, but the overall height can be made smaller according to the invention.

In addition, it is advantageous if the auxiliary circuit board completely covers the indentation of the circuit board also has a portion extending beyond it. When such an inverted arrangement is considered, and when a reflow soldering process is used on a conveyor belt driven into an oven, the electric component holds from the lower side of the auxiliary circuit board, which is held in turn by the circuit board. In this case, the spacing elements can be arranged especially advantageously between the remainder of the auxiliary circuit board and an edge section of the circuit board located on the side of the indentation of the circuit board. The simple upside-down insertion of the auxiliary circuit board in connection with the arrangement formed with the electric component in the indentation makes further complicated or expensive holding device or attachment devices superfluous for the auxiliary circuit board, which is advantageous.

In using a reflow soldering process for solid soldering of the auxiliary circuit board to the circuit board, it is advantageous that the electric component be attached by means of solder to the auxiliary circuit board, which remains stable in shape at the temperatures used for the reflow process. In this way, the electric component can be prevented from falling from the auxiliary circuit board while the auxiliary circuit board is being solid-soldered to the circuit board. An attachment of the electric component by means of solder to the auxiliary circuit board has the additional advantage that both the mechanical attachment of the electric component and the contacts of the connectors of the component with the first connection areas of the auxiliary circuit board can be made in one step.

A flexible circuit board can be used as the circuit board. In a flexible circuit board, levels can be formed that make the use of spacing elements on the circuit board superfluous.

With this, the second connecting surfaces of the auxiliary circuit board are in direct contact with the connecting surfaces of the circuit board. Specifically, by means of the levels, the component remainder of the electric component beyond the circuit board can be set by the height of the level. A flexible auxiliary circuit board thus also has the advantage that spacing elements can be avoided, which simplifies the structure of the component arrangement according to the invention.

In selecting the flexibility of the auxiliary circuit board, care should be taken that the flexibility, thus the elasticity of circuit board is sufficient for it to change shape. In addition, the auxiliary circuit board must have sufficient stiffness that the levels formed essentially remain and are not strongly diminished in height by the weight of the component.

In another embodiment of the invention, the auxiliary circuit board can also be attached to the upper side of the circuit board.

For this, a shape of the auxiliary circuit board is especially appropriate in which the auxiliary circuit board has a cross-section in the form of a U. The auxiliary circuit board also has holding segments pointing outward that are attached to the circuit board.

In addition, in an advantageous embodiment of the invention, an electrically conducting screen can be arranged on the side of the component opposite the auxiliary circuit board. Such a screen can perform several functions. It can collect a component consisting of several partial components into a mechanically stable unit. In addition, such a screen can serve for electric screening of the component. Generally, the component ground is connected by the screening to the system ground found on the circuit board.

The screen covers the surface of the component at least partially in a flat manner.

In connection with a flexible auxiliary circuit board, the screen can be implemented with greater stiffness than that of the flexible circuit board and, in addition, it can be attached to the component and the circuit board in such a way that the component remainder of the component over the circuit board can be set by means of the screen.

A plate of sheet metal, for example, can be considered as the screen.

In the following, the invention will be explained in more detail with reference to an embodiment example and the associated diagrams.

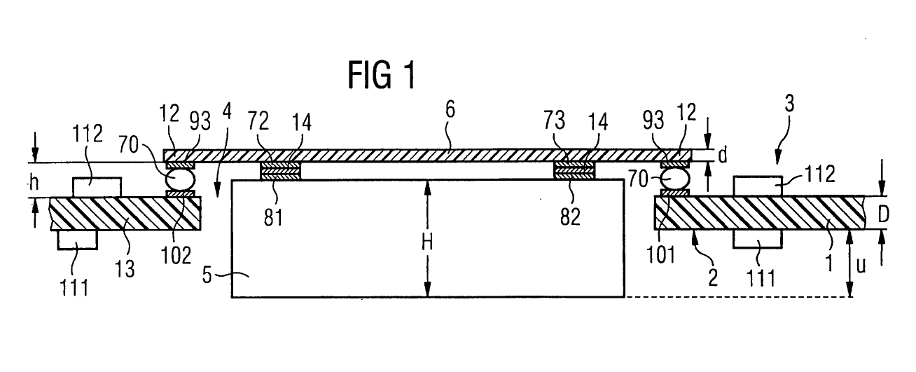

FIG. 1 shows, as an example, a component arrangement according to the invention, upside down in a schematic cross-section.

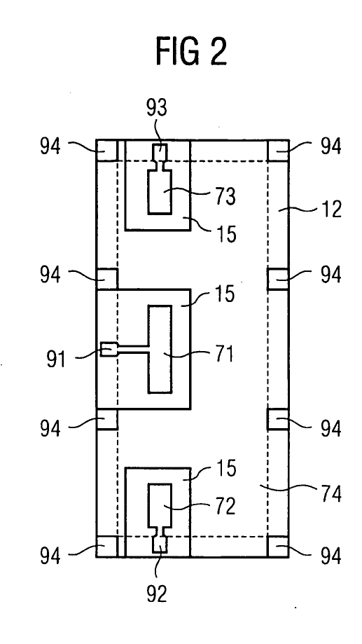

FIG. 2 shows, as an example, the auxiliary circuit board from FIG. 1 in a top view.

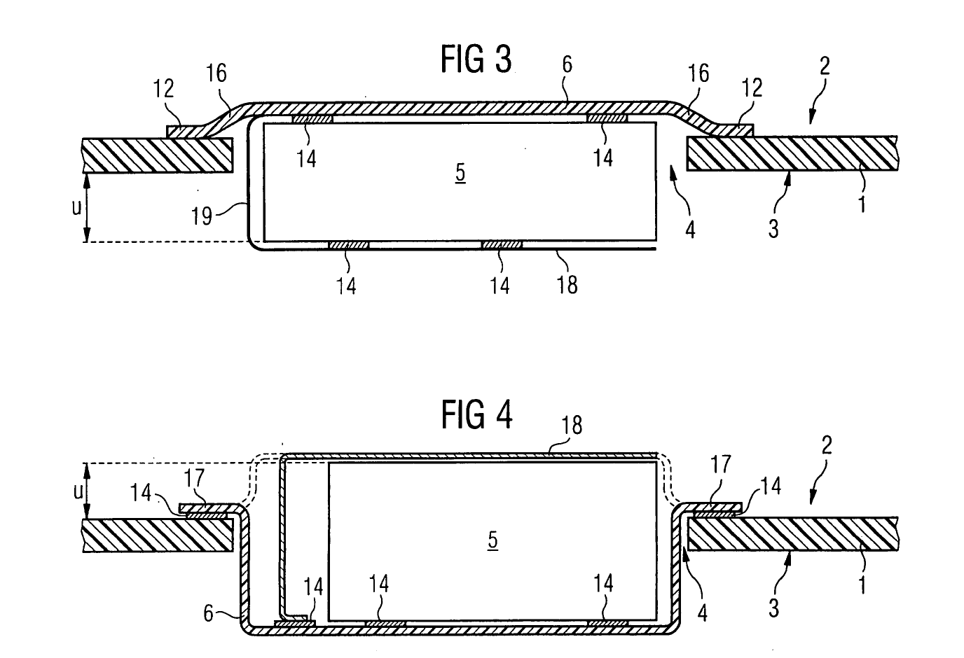

FIG. 3 shows, as an example, another component arrangement according to the invention upside-down in a schematic cross-section, wherein a flexible circuit board is presented.

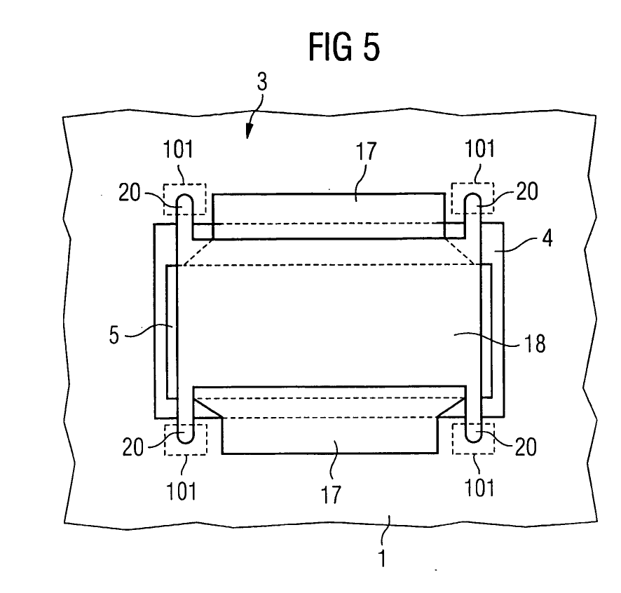

FIG. 4 shows, as an example, another component arrangement according to the invention from the side in a schematic cross-section. Two variants of a screen are presented here.

FIG. 5 shows a top view of the second variant presented in FIG. 4.

FIG. 1 shows a component arrangement with a circuit board 1 that has an indentation 4. The circuit board 1 also has an upper side 2 and a lower side 3. The indentation 4 is dimensioned here in such a way that the electric component 5 has room in it. The electric component 5, for example, can involve a microwave ceramic duplexer that can be used as a filter for PCS-CDMA. Such filters are used especially in mobile-radio applications.

The goal of the invention is to reduce the remainder U of the electric component 5 on the upper side 2 of the circuit board 1.

On the upper side of the component 5 connectors 81, 82 are arranged, which can be, for example, metal-plated areas of a ceramic filter. These connectors 81, 82 of the electric component 5 are soldered to connecting surfaces 72, 73 of an auxiliary circuit board directly above them. The soldering is done by means of solder 14. The solder 14 can be a solder that is relatively stable to heat, for example with composition of tin and silver that has a tin content of 96%. Such a solder melts above 230° C., which represents the short-term peak temperature for a usual reflow soldering process. This reflow soldering process can be used in the subsequent mounting of the auxiliary circuit board 6 onto the circuit board 1. Through the high-melting solder 14 the electric component 5 is prevented from falling from the auxiliary circuit board 6.

The first connection areas 72, 73 of the auxiliary circuit board 6 are connected so as to conduct electricity by means of suitable conducting paths (cf. FIG. 2) to second connecting surfaces 92, 93 of the auxiliary circuit board 6. These second connecting surfaces 92, 93 of the auxiliary circuit board 6 lie directly above corresponding connection areas 101, 102 of circuit board 1, with they are in contact by means of pieced formed from solder that function as spacing elements 70. With this, the height h of the spacing elements 70 determines component remainder U.

For the component remainder U to be reduced with the other quantities

h=height of the spacing elements 70

H=height of the component 5

D=circuit board 1

d=thickness of the auxiliary circuit board 6 (without regard to the connection, represented excessively large, between the component 5 and the auxiliary circuit board 6) the following relationship applies, approximately:

U=H−h−D.

In the embodiment example shown as an example in FIG. 1, the following dimensions apply: H=4.3 mm, D=0.9 mm, d=0.3 mm, h=1.1 mm. For the component remainder U, the result is approximately U=2.3. mm.

In particular, it is clear in FIG. 1 that the thickness d of the auxiliary circuit board 6 can be significantly smaller than the thickness D of the circuit board 1, since the auxiliary circuit board 6 has a significantly smaller area and therefore a reduced circuit-board thickness with lower stability is sufficient.

To assemble the component arrangement presented in FIG. 1, an auxiliary circuit board 6 provided with an electric component 5 is placed from above on the lower side 3 of the circuit board 1, whereby the spacing element 70 is implemented as a piece formed from solder. Then this arrangement can be driven through an oven, where it is heated to 215 to 230° C., whereby the pieces formed from solder melt, at which time the auxiliary circuit board 6 is attached to the circuit board 1 by means of a reflow soldering process and the component arrangement according to the invention arises.

In this case, the electric component 5 is arranged on the same side of the auxiliary circuit board 6 as the spacing elements 70.

The auxiliary circuit board 6 covers the indentation 4 completely, and it also has a remainder 12 that is located over an edge section 12 of the circuit board 1 on the same side of the circuit board 1 as the indentation. One or more spacing elements 70 can be arranged in a simple way and manner between the remainder 12 and the edge section 13.

According to FIG. 2, the auxiliary circuit board 6 has first connecting surfaces 71, 72, 73, 74, which are used for the case of a duplexer: connection 71 for the antenna, connection 72 for the receiving channel, connection 73 for the sending channel, and finally connection 74 for the ground. The first connection areas 71, 72, and 73 of the auxiliary circuit board 6 are separated from the ground connection 74 by metal-free areas 15. Second connection areas 94 are provided for contacting the ground connection 94, on which the spacing elements 70 are placed. In addition, second contact areas 91, 92, 93 are provided for contacting the first connection areas 71, 72, 73, which are in electrical contact with the first 71, 72, 73. Spacing elements 70 are also placed on these second connecting surfaces 91, 92, 93. Congruent with the second connection areas 91, 92, 93, 94 of the auxiliary circuit board 6 that are shown in FIG. 2, corresponding connection areas are arranged on the circuit board 1, of which, for example, contacting areas 101 and 102 are provided to contact second connecting surfaces 92 and 93.

FIG. 3 shows another component arrangement according to the invention, in which the auxiliary circuit board 6 is a flexible circuit board. Levels are formed in the flexible circuit board that are attached to the component remainder U of the component 5 over the circuit board 1. The component 5 is attached to the auxiliary circuit board 6 by means of solder. With the levels 16 formed in the flexible circuit board 6, the spacing elements shown in FIG. 1 can be omitted, whereby the structure of the component arrangement can be simplified. The auxiliary circuit board 6 likewise has a remainder 12, as in FIG. 1, with the aid of which the auxiliary circuit board 6 is attached to the lower side of the circuit board 1.

A screen 18 is arranged on the side of the component 5 that faces the auxiliary circuit board 6. This screen 18 can be, for example, of electrically conducting sheet metal. Nickel-silver sheet metal with a thickness of 0.15 mm can be considered, for example. The screen 18 can be soldered to the component 5. The component 5 can also consist of several partial elements, which are then soldered individually to the screen 18 or attached to the screen 18. In this way, the partial components are held together and for the component 5. The screen 18 in this case has the function of screening the electric component 5. In addition, the component ground is connected to that of the system ground by means of the screen 18. The system ground is located on the circuit board 1. The flexible circuit board 6 can be implemented, for example, on the basis of polyimide material with a thickness of 0.2 mm. The screen 18 can be connected, for example, by means of a connecting ware 19 or a wire 19 corresponding to the shape of the sheet metal 18, to a corresponding ground connection, on the auxiliary circuit board 6. Otherwise, FIG. 1 [sic]shows elements corresponding to the reference numbers of FIG. 1.

FIG. 4 shows another embodiment of the component arrangement according to the invention. Component 5 is again lowered into an indentation 4 on the circuit board.

The auxiliary circuit board 6 is implemented as a flexible circuit board formed in such a way that it has the shape of a trough, whereby the trough has holding segments 17 pointing outward, which are attached to the circuit board 1. According to the arrangement shown in FIG. 4, the auxiliary circuit board 6 is a two-sided circuit board, in which the first connection areas of the auxiliary circuit board 6, which serve for attachment and contacting the connection areas of the auxiliary circuit board 6, are arranged on the side of the auxiliary circuit board facing one of the second connection areas of the auxiliary circuit board 6. The second connection areas of the auxiliary circuit board 6 serve to connect the auxiliary circuit board 6 with corresponding connectors or connection areas of the circuit board 1 and also serve to wire the component 5 to corresponding connectors on the circuit board 1. The auxiliary circuit board 6 can be, for example, a two-sided circuit board on a polyimide base. Contacts through the polyimide material from top to bottom can be made with rivets, for example.

On the upper side of the component 5, a screen 18 is arranged that has, in a first variant, the shape of an angle bracket, whereby the leg of the screen 18 that points downward is soldered to the auxiliary circuit board 6 by means of solder 14. In a second variant, the screen 18 is attached both to the component 5 and to the circuit board 1. In this case, the component remainder U of the component 5 beyond the circuit board 1 is defined by the screen 18, which is relatively stiff in comparison to the auxiliary circuit board 6. At least part of the screen 18 must extend beyond the indentation 4 for this purpose. This occurs, as can be seen from FIG. 5, by the screen 18 being provided with extensions 20 attached to the connection areas 101 of the circuit board 1. The connection areas 101 mentioned serve in this case to connect the screen 18 to the system ground. FIG. 5 shows a top view of the second variant of FIG. 4. The auxiliary circuit board 6 is shaped in this case in such a way that the holding segments 17 have a reduced width, so that space remains in edge segment directly adjacent to the indentation 4 for attachment of the extensions 20 of the screen 18.

Another function of the screen 18 is mechanical stabilization of the auxiliary circuit board 6, since the mechanical stability of the component arrangement is additionally increased by attaching the relatively stiff screen 18, which can be a metallic strip, for example, to the electric component 5, on the one hand, and to the circuit board 1, on the other.

For all diagrams, corresponding reference numbers identify corresponding elements.

1. A component arrangement comprising:
a circuit board having an upper side, a lower side, and an indentation;
an auxiliary circuit board attached to the circuit board; and
an electrical component that is disposed in the indentation and is attached to the auxiliary circuit board.

2. The component arrangement according to claim 1, wherein the auxiliary circuit board is attached to the lower side of the circuit board.

3. The component arrangement according to claim 1, further comprising:
one or more spacing elements between the auxiliary circuit board and the circuit board, the one or more spacing elements defining, a distance between the auxiliary circuit board and the circuit board.

4. The component arrangement according to claim 1, wherein:
the auxiliary circuit board has first connection areas and the electrical component has second connection areas, the first connection areas for establishing electrical contact with the second connection areas;
the auxiliary circuit board has third connection areas and the electrical component has fourth connection areas, the third connection areas for establishing electrical contact with the fourth connection areas; and
the first connection areas are electrically connected to the third connection areas to allow conduction of electricity.

5. The component arrangement according to claim 4, wherein electrical contact between the third connection areas and the fourth connection areas is achieved via one or more spacing elements.

6. The component arrangement according to claim 1, wherein the auxiliary circuit board is thinner than the circuit board.

7. The component arrangement according to claim 1, wherein additional electrical components are arranged on the upper side and on the lower side of the circuit board.

8. The component arrangement according to claim 1, wherein:
the auxiliary circuit board is completely covered by the indentation except for a remainder area; and
one or more spacing elements are arranged between an edge section on a side of the indentation and the remainder area.

9. The component arrangement according to claim 1, wherein the component is attached to the auxiliary circuit board via solder, the auxiliary circuit board being stable in shape at temperatures associated with a reflow soldering process.

10. The component arrangement according to claim 4, wherein:
the auxiliary circuit board is flexible;
the third connection areas are connected directly to the fourth connection areas; and
at least one level is formed via the auxiliary circuit board.

11. A The component arrangement according to one of claim 4, wherein the auxiliary circuit board is attached to the upper side (2) of the circuit board.

12. The component arrangement according to claim 11, wherein the auxiliary circuit board has a U-shaped cross-section and holding segments pointing outward that attach to the circuit board.

13. The component arrangement according to claim 12, wherein:
the auxiliary circuit board is two-sided; and
the first connection areas and the third connection areas are arranged on different sides of the auxiliary circuit board.

14. The component arrangement according to claim 13, wherein the third connection areas are arranged on the holding segments.

15. The component arrangement according to claim 1, wherein a side of the electrical component facing away from the auxiliary circuit board is at least partially covered by a flat electrically conducting screen.

16. The component arrangement according to claim 15, wherein:
the auxiliary circuit board is a flexible circuit;
the electrically conducting screen is comprised of a material with lower flexibility than the auxiliary circuit board (6); and
the electrically conducting screen is attached to both the electrical component and the circuit board.
